(19) United States
(12) Patent Application Publication
(10) Pub. No.: US 2009/0183594 A1
(43) Pub. Date: Jul. 23, 2009

(54) Clutch for starters

(75) Inventor: Shinji Usami, Okazaki-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 12/318,905

(22) Filed: Jan. 12, 2009

(30) Foreign Application Priority Data
Jan. 17, 2008 (JP) 2008-007949

(51) Int. Cl. F02N 15/02

(52) U.S. Cl. 74/7 C

(57) ABSTRACT

A clutch is provided with a flat washer arranged in contact with an end surface at a pinion gear side of an outer clutch in an axial direction, a half-divided washer that is arranged adjoining the flat washer of the pinion gear side in its axial direction, and a covering member that fits into the perimeter of the pinion neck portion, and is arranged adjoining the pinion gear side in the axial direction of the half-divided washer so that the covering member prevents the foreign substances, such as dust or moisture that enter into the inside of the clutch. A clutch cover fixes the washers and the covering member to the clutch. The covering member is formed of the paper material, for example, into which oil is infiltrated and has one slit in the direction of a circumference for easy attaching to the pinion neck portion.

### CROSS-REFERENCE TO RELATED APPLICATION

This application is based on and claims the benefit of priority from earlier Japanese Patent Application No. 2008-7949 filed Jan. 17, 2008, the description of which is incorporated herein by reference.

### BACKGROUND OF THE INVENTION

1. Technical Field of the Invention

The present invention relates to a clutch for starters that transmits a drive torque of a motor to a pinion gear.

2. Description of the Related Art

As a prior art, a starter disclosed in Japanese Patent Application Laid-Open Publication No. 1-92574 is well known. This starter has a sealing mechanism that seals an opening between an inner peripheral surface of a housing and a perimeter surface of a clutch. This sealing mechanism comprises a magnet attached in the inner peripheral surface of the housing or the perimeter surface of the clutch, and a magnetic fluid that is held by the magnet and with which the opening is filled up. Thereby, outstanding waterproofing and protection against dust are obtained because the opening is completely sealed by the magnetic fluid.

In addition, there will be no problem raised at the time of the usual use of the starter, however, when vehicles is used in extremely unfavorable conditions, such that the vehicles run on a rough road, for example, then there will be a possibility that dust or water that is splashed up by the ring gear may enter into the inside of the starter from the opening of the housing.

However, the art disclosed in the above-mentioned Japanese Patent Application Laid-Open Publication No. 1-92574 shows the sealing mechanism that seals the opening between the inner peripheral surface of the housing and the perimeter surface of the clutch, and even if the entrance of the foreign substances into the motor side can be prevented, preventing the entrance of foreign substances into the inside of the clutch is not considered.

For this reason, it is a concern that when used under very severe conditions, the foreign substances may enter into the inside of the clutch, and there is a possibility of causing the performance fall by the poor operation of the clutch because the foreign substances containing moisture, such as dusts, enters into the sliding part of the clutch.

### SUMMARY OF THE INVENTION

The present invention has been made in light of the circumstances provided above, and has as its object to provide a clutch for starters in which entrance of foreign substances into an inside of the clutch can be suppressed under very severe operating conditions, so that the performance fall of the clutch can be prevented.

In the clutch for starters according to a first aspect, a clutch for starters that transmits a drive torque of a motor to a pinion gear comprises an outer clutch having a cam chamber formed in its inner circumference, a wall surface formed on an anti-pinion gear side in the axial direction of the cam chamber, and an opening formed on the pinion gear side in the axial direction of the cam chamber, an inner clutch arranged relatively rotatably to an inner diameter side of the outer clutch, and a clutch roller arranged in the cam chamber on the perimeter of the inner clutch for transmitting a torque between the outer clutch and the inner clutch.

A clutch for starters further comprises a flat washer arranged in contact with an end surface at the pinion gear side of the outer clutch in the axial direction that blockades the pinion gear side of the cam chamber in the axial direction, a half-divided washer divided into two pieces in the direction of its diameter that is arranged adjoining the flat washer of the pinion gear side in its axial direction, a plate-shaped covering member arranged adjoining the pinion gear side in the axial direction of the half-divided washer for preventing foreign substances from entering into the cam chamber, and a clutch cover that fixes the flat washer, the half-divided washer, and the covering member to the outer clutch.

According to the above-mentioned composition, by arranging the covering member to the pinion gear side in the axial direction of the half-divided washer, the entrance of foreign substances into the inside of the clutch (the cam chamber) can be prevented, and the performance fall of the clutch accompanied by poor operation can be prevented as well.

In the clutch for starters according to a second aspect, a small diameter cylindrical portion having a smaller outer diameter than the outer diameter of the inner clutch is formed in the pinion gear side of the inner clutch, the half-divided washer and the covering member are arranged at the perimeter of the small diameter cylindrical portion, and the covering member has one slit cut in the direction of the diameter from an inner edge to an outer edge of the covering member.

In the clutch for starters according to a third aspect, the slit of the covering member and a joint part of the half-divided washer are positioned separately in the direction of the circumference.

In the clutch for starters according to a fourth aspect, there is provided a space between the inner diameter of the covering member and the outer diameter of the small diameter cylindrical portion, and the width of the space is set to 1 mm or less.

In the clutch for starters according to a fifth aspect, there is provided a cylindrical portion in the inner circumference of the covering member that is prolonged to the pinion gear side cylindrically along with the perimeter of the small diameter cylindrical portion.

In the clutch for starters according to a sixth aspect, the covering member is formed of a paper material into which oil is infiltrated.

In the clutch for starters according to a seventh aspect, the covering member is formed of a resin material.

In the clutch for starters according to an eighth aspect, the covering member is formed of a rubber material.

### BRIEF DESCRIPTION OF THE DRAWINGS

In the accompanying drawings:

FIG. 1 shows an entire figure of a starter;

FIG. 2A shows a half sectional view of a clutch in a direction of a diameter;

FIG. 2B shows a half sectional view of the clutch taken along the line A-A of FIG. 2A (First Embodiment);

FIG. 3A shows a plane view of a flat washer;

FIG. 3B shows a sectional view of the flat washer taken along the line B-B of FIG. 3A;

FIG. 4A shows a plane view of a half-divided washer;

FIG. 4B shows an end surface of the half-divided washer taken along the line C-C of FIG. 4A;

FIG. 5A shows a plane view of a covering member;

FIG. 5B shows a sectional view of the covering member taken along the line D-D of FIG. 5A (First Embodiment);

FIG. 6 shows a half-sectional view of the clutch and a pinion gear (Second Embodiment);

FIG. 7A shows a plane view of the covering member; and

FIG. 7B shows a sectional view of the covering member taken along the line E-E of FIG. 7A (Second Embodiment).

### DETAILED DESCRIPTION OF THE PREFERRED EMBODIMENTS

With reference to the accompanying drawings, an embodiment of the present invention will now be described in detail.

### First Embodiment

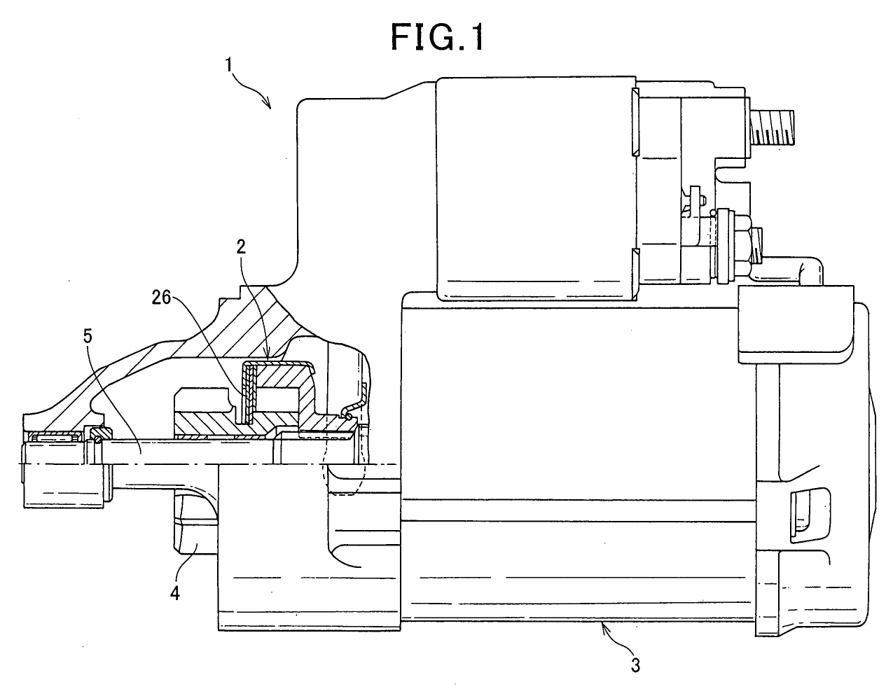

FIG. 1 shows an entire figure of a starter 1.

A clutch 2 of the present invention is used for the starter 1 shown in FIG. 1 for starting an engine, and the clutch 2 transmits a drive torque of a motor 3 to a pinion gear 4.

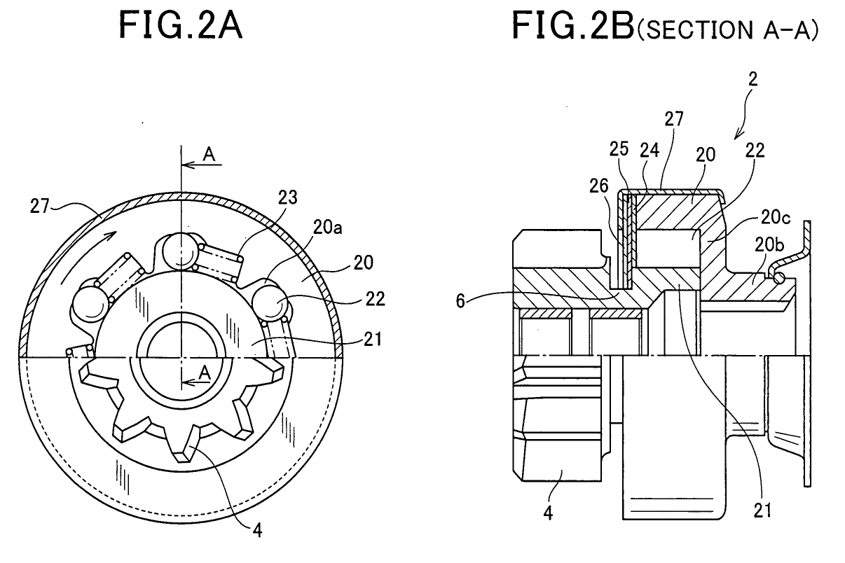

Hereafter, a composition of the clutch 2 is explained based on FIGS. 2-5.

The clutch 2 of the present embodiment shown in FIGS. 2A and 2B comprises an outer clutch 20 with a plurality of cam chambers 20a formed in its inner circumference, an inner clutch 21 arranged relatively rotatably to an inner diameter side of the outer clutch 20, clutch rollers 22 arranged in each cam chamber 20a on the perimeter of the inner clutch 21, springs 23 that press each clutch roller 22 in the direction of a narrow portion of each cam chamber 20a, and a clutch cover 27 that fixes two sheets of washers 24 and 25 and a sheet of covering member 26 to the outer clutch 20.

The outer clutch 20 is formed integrally with a barrel portion 20b that is connected with a perimeter of the output shaft 5 via helical spline engagement. An anti-pinion gear side in the axial direction of the cam chambers 20a is blockaded by a wall surface 20c connected with the barrel portion 20b, and an opening is formed on a pinion gear side in the axial direction of the cam chambers 20a.

Each of cam chamber 20a is formed in a shape of a wedge narrowing gradually from one side to the other in the direction of a circumference to the perimeter side of the inner clutch 21. In addition, the one side of the cam chamber 20a in the direction of the circumference (it is called a wider side) is formed larger than the diameter of the clutch roller 22, while the other side of the cam chamber 20a in the direction of the circumference (called the narrower side) is formed smaller than the diameter of the clutch roller 22. Further, grease for lubrication is poured into each cam chamber 20a.

The inner clutch 21 is provided integrally with the pinion gear 4. A small diameter cylindrical portion, or a pinion neck portion 6 in this embodiment (refer to FIG. 2B), is formed between the inner clutch 21 and the pinion gear 4. The outer diameter of the pinion neck portion 6 is formed smaller than the outer diameter of the inner clutch 21.

When the drive torque of the motor 3 is transmitted to the outer clutch 20 and the outer clutch 20 rotates in the direction of an arrow shown in FIG. 2A, the clutch rollers 22 are put between the outer clutch 20 and the inner clutch 21 in the narrower side of the cam chambers 20a, thus the rotation of the outer clutch 20 is transmitted to the inner clutch 21.

On the other hand, when the rotation of the engine is transmitted to the pinion gear 4 and the rotation speed of the inner clutch 21 exceeds the rotation speed of the outer clutch 20, the clutch rollers 22 move to the wider side of the cam chambers 20a so that the outer clutch 20 runs idle, thus the transfer of the torque between the outer clutch 20 and the inner clutch is intercepted.

The two sheets of washers 24 and 25 are a flat washer 24 arranged in contact with an end surface at the pinion gear side of the outer clutch 20 in the axial direction, and a half-divided washer 25 that is arranged adjoining the flat washer 24 of the pinion gear side in its axial direction.

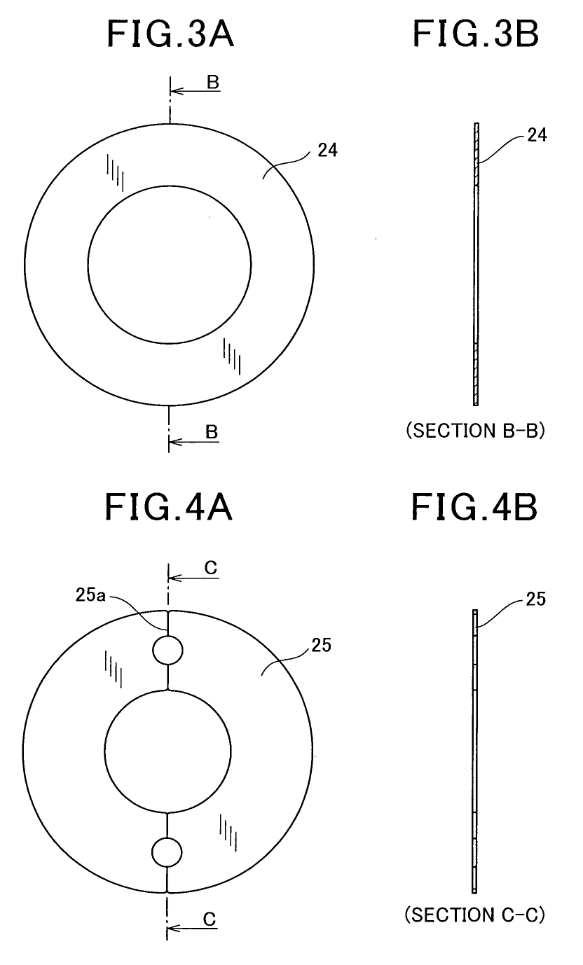

The flat washer 24 has a shape of a ring form, as shown in FIGS. 3A and 3B, and prevents the clutch rollers 22 to jump out from the cam chambers 20a by blocking the pinion gear side of the cam chambers 20a in the axial direction.

The half-divided washer 25 is divided into two pieces in the direction of its diameter, as shown in FIGS. 4A and 4B, and is assembled on the perimeter of the pinion neck portion 6.

The inner diameter of the half-divided washer 25 is formed smaller than the outer diameter of the inner clutch 21. The half-divided washer 25 holds the pinion gear side of the end surface of the inner clutch 21 in its axial direction so that it prevents the inner clutch 21 to escape from the outer clutch 20 in the axial direction.

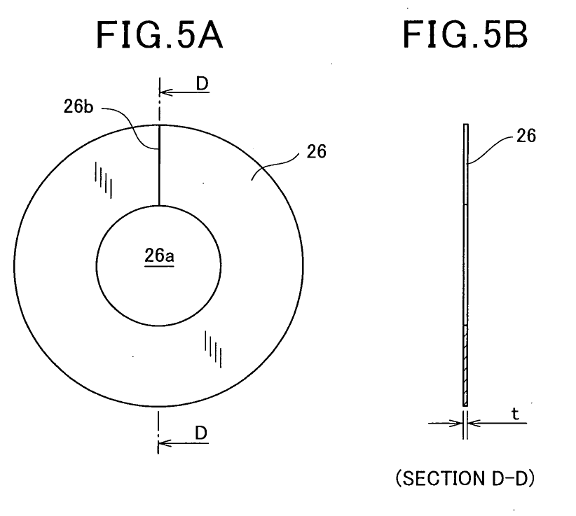

The covering member 26 shown in FIGS. 5A and 5B is formed of the paper material, for example, into which oil is infiltrated (for example, Nomex, which is a registered trademark), and it has the shape of a plate of thickness ‘t’ about 0.5 mm-2 mm. The covering member 26 is provided with a round hole 26a as an opening to the central part thereof in the direction of a diameter to form the shape of a ring, and has a slit 26b cut in the direction of the diameter from an inner edge of the round hole 26a to an outer edge of the covering member 26.

The covering member 26 fits into the perimeter of the pinion neck portion 6, and is arranged adjoining the pinion gear side in the axial direction of the half-divided washer 25. The covering member 26 prevents foreign substances, such as dust or moisture that enter into the inside of the clutch 2. Further, the inner diameter of the round hole 26a of the covering member 26 is formed a little greater that the outer diameter of the pinion neck portion 6. Specifically, a width of a space made between the inner diameter of the round hole 26a and the outer diameter of the pinion neck portion 6 is set to 1 mm or less.

The clutch cover 27 fixes the flat washer 24, the half-divided washer 25, and the covering member 26 in an overlapped form to the outer clutch 20. However, the covering member 26 and the half-divided washer 25 are arranged in the position so that the slit 26b of the covering member 26 does not correspond with the joint part 25a of the half-divided washer 25, i.e., the slit 26b of the covering member 26 and the joint part 25a of the half-divided washer 25 (refer to FIG. 4A) are positioned separately in the direction of the circumference.

### [Effect of the First Embodiment]

Since the clutch 2 of the present embodiment has the plate-like covered member 26 arranged adjoining the pinion gear side in the axial direction of the half-divided washer 25 the entrance of the foreign substances, such as dust or moisture, into the inside of the clutch 2 (the cam chambers 20a) can be prevented. Consequently, even in very severe operating conditions, the performance fall by the poor operation of the clutch 2 can be prevented, thus desired starter performance is maintainable.

Especially the covering member 26 has the width of the space between the inner diameter of the round hole 26a and the outer diameter of the pinion neck portion 6, which is set to 1 mm or less. In this case, the covering member 26 does not contact the perimeter of the pinion neck portion 6 at the time of the operation of the clutch 2, therefore wear of the covering member 26 and the rotation loss of the pinion gear 4 may be avoided. In addition, entrance of foreign substances from the space into the clutch 2 can be suppressed by setting the opening as small as possible.

Further, the covering member 26 has one slit 26b in the direction of a circumference for easy attaching to the pinion neck portion 6, and the slit 26b and the joint part 25a of the half-divided washer 25 are positioned separately in the direction of the circumference. By this, even if the foreign substances enters through the slit 26b of the covering member 26, the foreign substances are suppressed to enter into the clutch 2 through the space made on the joint part 25a of the half-divided washer 25, thus the effect of preventing the foreign substances by the covering member 26 is securable.

### Second Embodiment

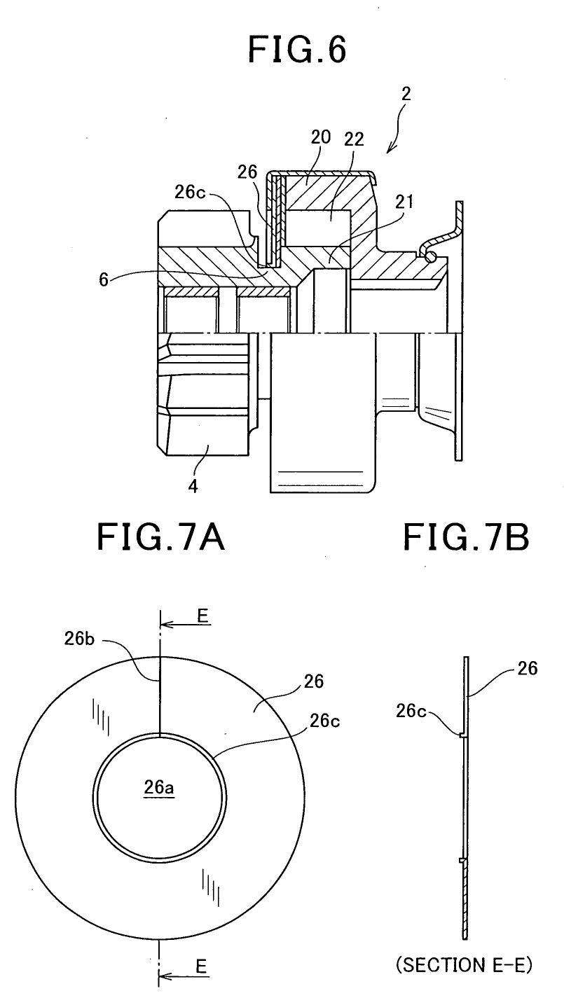

FIG. 6 shows the half-sectional view of a clutch 2 and pinion gear 4, FIG. 7A shows the plane view of the covering member 26, and FIG. 7B of shows the sectional views of the covering member 26 taken along the line E-E of FIG. 7A.

The covering member 26 of the second embodiment shown in FIGS. 7A and 7B has a cylindrical portion 26c in the inner circumference of the round hole 26a. As shown in FIG. 6, the cylindrical portion 26c is prolonged to the pinion gear side cylindrically along with the perimeter of the pinion neck portion 6. In this case, the space made between the inner diameter of the covering member 26 (inner diameter of the cylindrical portion 26c) and the outer diameter of the pinion neck portion 6 can be formed longer in the axial direction. That is, since the space can be formed as the length of cylindrical portion 26c, the entrance of the foreign substances into the inside of the clutch 2 (the cam chambers 20a) can be prevented more certainly.

### MODIFICATION

The material used for the covering member 26 is not limited to a paper material, but a resin material, a rubber material, etc., for instance, can also be used.

The clutch 2 mentioned in the first embodiment is provided integrally with the pinion gear 4, though the present invention is applicable also to the starter that constitutes the both separately.

What is claimed is:

1. A clutch for starters that transmits a drive torque of a motor to a pinion gear comprising:
an outer clutch having a cam chamber formed in its inner circumference, a wall surface formed on the anti-pinion gear side in the axial direction of the cam chamber, and an opening formed on the pinion gear side in the axial direction of the cam chamber;
an inner clutch arranged relatively rotatably to an inner diameter side of the outer clutch;
a clutch roller arranged in the cam chamber on the perimeter of the inner clutch for intermitting a torque between the outer clutch and the inner clutch;
a flat washer arranged in contact with an end surface at the pinion gear side of the outer clutch in the axial direction that blockades the pinion gear side of the cam chamber in the axial direction;
a half-divided washer divided into two pieces in the direction of its diameter that is arranged adjoining the flat washer of the pinion gear side in its axial direction;
a plate-shaped covering member arranged adjoining the pinion gear side in the axial direction of the half-divided washer for preventing foreign substances from entering into the cam chamber; and
a clutch cover that fixes the flat washer, the half-divided washer, and the covering member to the outer clutch.

2. The clutch for starters of claim 1,
wherein a small diameter cylindrical portion having a smaller outer diameter than the outer diameter of the inner clutch is formed in the pinion gear side of the inner clutch;
the half-divided washer and the covering member are arranged at the perimeter of the small diameter cylindrical portion; and
the covering member has one slit in the direction of a circumference cut in the direction of the diameter from an inner edge to an outer edge of the covering member.

3. The clutch for starters of claim 2,
wherein the slit of the covering member and a joint part of the half-divided washer are positioned separately in the direction of the circumference.

4. The clutch for starters of claim 2,
wherein there is provided a space between the inner diameter of the covering member and the outer diameter of the small diameter cylindrical portion, and the width of the space is set to 1 mm or less.

5. The clutch for starters of claim 4,
wherein there is provided a cylindrical portion in the inner circumference of the covering member that is prolonged to the pinion gear side cylindrically along with the perimeter of the small diameter cylindrical portion.

6. The clutch for starters of claim 1,
wherein the covering member is formed of a paper material into which oil is infiltrated.

7. The clutch for starters of claim 1,
wherein the covering member is formed of a resin material.

8. The clutch for starters of claim 1,
wherein the covering member is formed of a rubber material.
